(19) United States
(12) Patent Application Publication
(10) Pub. No.: US 2025/0220520 A1
(43) Pub. Date: Jul. 3, 2025

(54) METHODS AND APPARATUSES FOR LOGGING AND REPORTING CELL SWITCH EVENT

(71) Applicant: LENOVO (BEIJING) LIMITED, Beijing (CN)

(72) Inventors: Congchi ZHANG, Shanghai (CN); Mingzeng DAI, Shanghai (CN); Le YAN, Shanghai (CN); Yibin ZHUO, Shanghai (CN); Xiaoying XU, Beijing (CN); Haiyan LUO, Shanghai (CN)

(21) Appl. No.: 18/867,239

(22) PCT Filed: May 20, 2022
(86) PCT No.: PCT/CN2022/094115

§ 371 Date: Nov. 19, 2024

(51) Int. Cl. H04W 36/00; H04W 36/08

(52) U.S. Cl. CPC H04W 36/0061; H04W 36/0072; H04W 36/00835; H04W 36/08

(57) ABSTRACT

Embodiments of the present disclosure relate to methods and apparatuses for logging and reporting cell switch event. According to an embodiment of the present disclosure, a user equipment (UE) may include: a processor configured to log information related to a cell switch event from a first cell to a second cell; and a transmitter coupled to the processor and configured to transmit the information related to the cell switch event to a base station (BS) when the UE connects to the first cell again; and a receiver coupled to the processor.

### TECHNICAL FIELD

Embodiments of the present application are related to wireless communication technology, and more particularly, related to methods and apparatuses for logging and reporting cell switch event.

### BACKGROUND

In some scenarios, a user equipment (UE) may move following a fixed pattern regularly during every day or every week. For example, a UE may take a same path from home to office every day, or vice versa. In another example, in a campus, a UE may move between different buildings in a specific pattern. In such scenarios, in order to let a base station (BS) know which direction the UE is moving in, such that the BS can make a correct handover decision and configure less measurement tasks to the UE, the UE may report some information to the BS. However, details regarding the information reported to the BS need to be further discussed.

### SUMMARY OF THE APPLICATION

Embodiments of the present application at least provide a technical solution for logging and reporting cell switch event.

According to some embodiments of the present application, a UE may include: a processor configured to log information related to a cell switch event from a first cell to a second cell; and a transmitter coupled to the processor and configured to transmit the information related to the cell switch event to a BS when the UE connects to the first cell again; and a receiver coupled to the processor.

In some embodiments of the present application, the cell switch event is a handover event when the UE is in a radio resource control (RRC)_CONNECTED state or a cell reselection event when the UE is in an RRC_INACTIVE or RRC_IDLE state.

In some embodiments of the present application, the receiver is configured to receive configuration information indicating the UE to log a cell switch event, the configuration information includes at least one of: a time period that the UE can store a logged cell switch event; a number of logs that the UE can store in total; a number of logs that the UE can store for a same cell; a list of cells that the UE can log cell switch events when the UE is connected to or camped on the list of cells, wherein the list of cells includes the first cell; an indication indicating whether the UE should log a cell reselection in an RRC_INACTIVE or RRC_IDLE state; or information to be logged related to a cell switch event.

In some embodiments of the present application, the information related to the cell switch event includes at least one of: an identity (ID) representing the second cell; a time stamp when the UE connects to the first cell in the cell switch event; a time period that the UE stays in the first cell before the cell switch event; an indicator indicating whether the cell switch event is a handover event or a cell reselection event; an indicator indicating whether the UE's current moving pattern is the same as a moving pattern when the UE connects to the first cell in the cell switch event; or an ID of the cell switch event.

In some embodiments of the present application, the configuration information is received in a dedicated RRC message to the UE or received in a system information block (SIB) message to one or more UEs including the UE.

In some embodiments of the present application, the receiver is further configured to receive a UE information request message requesting the information related to the cell switch event from the BS when the UE connects to the first cell again, and the transmitter is further configured to transmit the information related to the cell switch event in response to receiving the UE information request message.

In some embodiments of the present application, the transmitter is further configured to transmit a message indicating an availability of the information related to the cell switch event to the BS when the UE connects to the first cell again.

In some embodiments of the present application, the cell switch event is a handover event, the receiver is further configured to receive a message including configuration related to the handover event and an ID of the handover event from the BS.

In some embodiments of the present application, the transmitter is further configured to transmit a message indicating an availability of the ID of the handover event when the UE connects to the first cell again; the receiver is further configured to receive a UE information request message requesting the ID of the handover event from the BS, and the transmitter is further configured to transmit the ID of the handover event in response to receiving the UE information request message.

In some embodiments of the present application, the receiver is configured to receive a message requesting the UE to indicate whether the UE is moving according to a fixed pattern from the BS; the processor is further configured to determine whether the UE is taking a same path as last time, connecting to a same cell as last time, or passing by a same location as last time in response to receiving the message; and the transmitter is configured to transmit an indication indicating whether the UE is moving according to a fixed pattern to the BS based on the determining.

According to some other embodiments of the present application, a BS may include: a transmitter configured to transmit configuration information indicating to log a cell switch event to a UE; a receiver configured to receive information related to a cell switch event from a first cell to a second cell from the UE; and a processor coupled to the transmitter and the receiver.

In some embodiments of the present application, the configuration information includes at least one of: a time period that the UE can store a logged cell switch event; a number of logs that the UE can store in total; a number of logs that the UE can store for a same cell; a list of cells that the UE can log cell switch events when the UE is connected to or camped on the list of cells, wherein the list of cells includes the first cell; an indication indicating whether the UE should log a cell reselection in an RRC_INACTIVE or RRC_IDLE state; or information to be logged related to a cell switch event.

In some embodiments of the present application, the cell switch event is a handover event when the UE is in a RRC_CONNECTED state or a cell reselection event when the UE is in an RRC_INACTIVE or RRC_IDLE state.

In some embodiments of the present application, the information related to the cell switch event includes at least one of: an ID representing the second cell; a time stamp when the UE connects to the first cell in the cell switch event; a time period that the UE stays in the first cell before the cell switch event; an indicator indicating whether the cell switch event is a handover event or a cell reselection event; an indicator indicating whether the UE's current moving pattern is the same as a moving pattern when the UE connects to the first cell in the cell switch event; or an ID of the cell switch event.

In some embodiments of the present application, the configuration information is transmitted in a dedicated RRC message to the UE or transmitted in a SIB message to one or more UEs including the UE.

In some embodiments of the present application, the transmitter is further configured to transmit a UE information request message requesting the information related to the cell switch event to the UE when the UE connects to the first cell again, and the receiver is further configured to receive the information related to the cell switch event in response to transmitting the UE information request message.

In some embodiments of the present application, the receiver is further configured to receive a message indicating an availability of the information related to the cell switch event from the UE when the UE connects to the first cell again.

In some embodiments of the present application, the cell switch event is a handover event, the transmitter is further configured to transmit a message including configuration related to the handover event and an ID of the handover event to the UE, and the processor is further configured to store the ID together with the handover event.

In some embodiments of the present application, the receiver is further configured to receive a message indicating an availability of the ID of the handover event when the UE connects to the first cell again; the transmitter is further configured to transmit a UE information request message requesting the ID of the handover event to the UE, and the receiver is further configured to receive the ID of the handover event in response to transmitting the UE information request message.

In some embodiments of the present application, the transmitter is configured to transmit a message requesting the UE to indicate whether the UE is moving according to a fixed pattern from the BS; and the receiver is configured to receive an indication indicating whether the UE is moving according to a fixed pattern from the UE in response to the message.

According to some other embodiments of the present application, a method performed by a UE may include: logging information related to a cell switch event from a first cell to a second cell; and transmitting the information related to the cell switch event to a BS when the UE connects to the first cell again.

According to some other embodiments of the present application, a method performed by a BS may include: transmitting configuration information indicating to log a cell switch event to a UE; a receiver configured to receive information related to a cell switch event from a first cell to a second cell from the UE; and a processor coupled to the transmitter and the receiver.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates an exemplary VisitedCellInfoList IE as specified in 3GPP standard documents;

FIG. 3 illustrates a flowchart of an exemplary method for logging and reporting cell switch event according to some embodiments of the present application;

FIG. 4 illustrates a flowchart of another exemplary method for logging and reporting cell switch event according to some embodiments of the present application;

FIG. 5 illustrates a flowchart of another exemplary method for logging and reporting cell switch event according to some embodiments of the present application;

FIG. 6 illustrates a flowchart of another exemplary method for logging and reporting cell switch event according to some embodiments of the present application;

FIG. 7 illustrates a flowchart of another exemplary method for logging and reporting cell switch event according to some embodiments of the present application; and

FIG. 8 illustrates a simplified block diagram of an exemplary apparatus for for logging and reporting cell switch event according to some embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order shown or in sequential order, or that among all illustrated operations to be performed, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3GPP 5G (i.e., new radio (NR)), 3GPP long term evolution (LTE) Release 8 and so on. Persons skilled in the art know very well that, with the development of network architecture and new service scenarios, the embodiments in the present application are also applicable to similar technical problems; and moreover, the terminologies recited in the present application may change, which should not affect the principle of the present application.

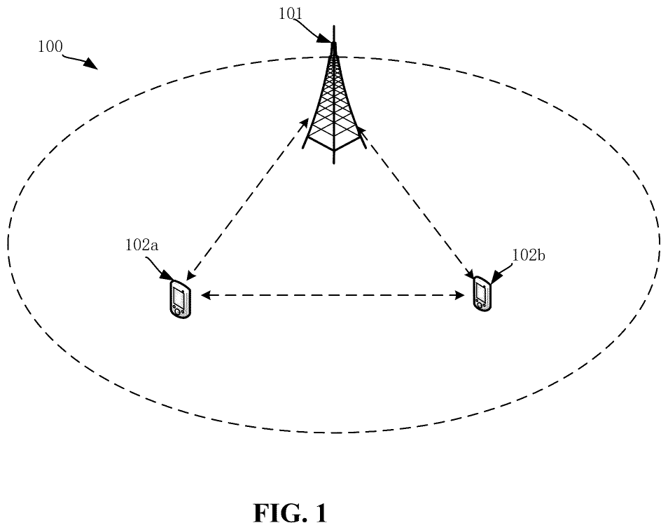

FIG. 1 is a schematic diagram illustrating an exemplary wireless communication system 100 according to some embodiments of the present application.

As shown in FIG. 1, the wireless communication system 100 includes at least one BS 101 and at least one UE (e.g., a UE 102a and a UE 102b). Although one BS and two UEs are depicted in FIG. 1 for illustrative purpose, it can be contemplated that any number of BSs and UEs may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

The BS 101 may also be referred to as an access point, an access terminal, a base, a macro cell, a radio access network (RAN) node, a next generation (NG) radio access network (RAN) node, a node-B, an enhanced node B (eNB), a gNB, a home node-B, a relay node, or a device, or described using other terminology used in the art. The BS 101 is generally part of a RAN that may include a controller communicably coupled to the BS 101.

According to some embodiments of the present application, the UE 102a and the UE 102b may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE. In an embodiment of the present application, the UE 102a may be a power-saving UE and the UE 102b may be a VUE. In another embodiment of the present application, both the UE 102a and the UE 102b may be VUEs or power-saving UEs.

According to some other embodiments of the present application, the UE 102a and the UE 102b may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE 102a and the UE 102b may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE 102a and the UE 102b may include wearable devices, such as smart watches, fitness bands, optical head-mounted displays, or the like.

Moreover, a UE may be referred to as a subscriber unit, a mobile, a mobile station, a user, a terminal, a mobile terminal, a wireless terminal, a fixed terminal, a subscriber station, a user terminal, or a device, or described using other terminology used in the art.

Both the UE 102a and the UE 102b in the embodiments of FIG. 1 are in a coverage area of the BS 101, and may transmit information or data to the BS 101 and receive control information or data from the BS 101, for example, via LTE or NR Uu interface. In some embodiments, the UE 102a and the UE 102b may communicate with each other via sidelink.

In order to let a BS know a UE is moving in which direction, such that the BS may make a correct handover decision and configure less measurement tasks to the UE, 3GPP has specified and discussed several methods. These methods may include:
1) Method 1: a UE (e.g., unmanned aerial vehicle (UAV)) reports it's planned flight path to the network;
2) Method 2: a BS with artificial intelligence (AI) and/or machine learning (ML) capability may predict UE's trajectory and/or mobility. For example, the BS may predict latitude, longitude, altitude, cell ID of a UE over a future period of time. In another example, the BS may predict a handover target node, candidate cells in conditional handover (CHO), together with the confidence of the predication for the UE.
3) Method 3: a UE can report a maximum of 16 most recently visited cells to a BS. For example, a BS may request a UE to provide some information from the UE side. Then, the UE may transmit a visited cell information list (e.g., VistedCellInfoList as specified in 3GPP standard documents) to the BS. The information element (IE) VisitedCellInfoList may include visited cell information for a maximum of 16 most recently visited cells. In some embodiments, the visited cell information list includes cells visited in RRC_IDLE, RRC_INACTIVE and RRC_CONNECTED states for NR and RRC_IDLE and RRC CONNECTED for E-UTRA.

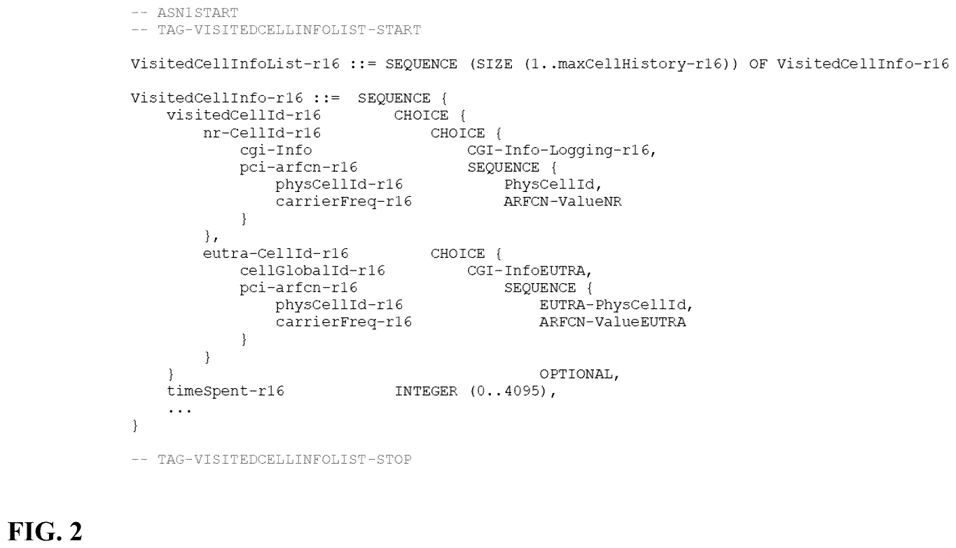

FIG. 2 illustrates an exemplary VisitedCellInfoList IE as specified in 3GPP standard documents.

Referring to FIG. 2, the VisitedCellInfoList-r16 IE may include visited cell information (e.g., VisitedCellInfo-r16) for a maximum of 16 most recently visited cells. Each VisitedCellInfo-r16 may include a visited cell ID (e.g., visitedCellId-r16) for a cell and a time spent in the cell (e.g., timeSpent-r16). The visitedCellIdmay be a NR cell ID (e.g., nr-CellId-r16) or an E-UTRA cell ID (e.g., eutra-CellId-r16).

Although the above three methods may be used to facilitate the BS to make a correct handover decision and configure less measurement tasks, they may be not suitable to be applied in some scenarios wherein a UE moves following a fixed pattern every time or most of time when it passes through a given cell. For such scenarios, using the above three methods may bring heavy signaling overhead and processing burden. Accordingly, some other methods need to be studied to facilitate the BS to make a right cell switch decision in such scenarios.

Given the above, embodiments of the present application propose solutions for logging and reporting cell switch event, which can facilitate the BS to make a right cell switch decision while reducing the signaling overhead and processing burden. More details on embodiments of the present application will be described in the following text in combination with the appended drawings.

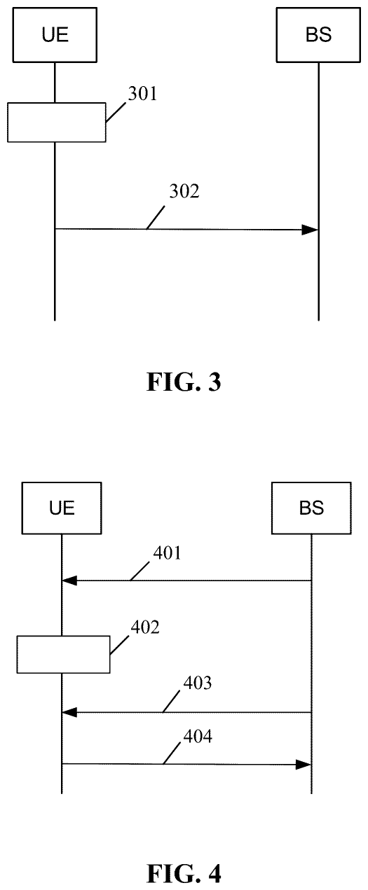

FIG. 3 illustrates a flowchart of an exemplary method for logging and reporting cell switch event according to some embodiments of the present application. The method illustrated in FIG. 3 may be performed by a UE (e.g., UE 102a102a or UE 102b102b as shown in FIG. 1) and a BS (e.g., BS 101101 as shown in FIG. 1). Although the method is illustrated in a system level, persons skilled in the art can understand that the method implemented in the UE and the BS can be separately implemented and incorporated in other apparatus with the like functions.

Referring to FIG. 3, a UE may connect to a cell (e.g., cell#1). When the UE is switched from the cell (e.g., cell#1) to another cell (e.g., cell#2), the UE may log and store information related to a cell switch event from the cell#1 to cell#2 in step 301.

In some embodiments of the present application, the cell switch event may be a handover event from cell#1 to cell#2 when the UE is in an RRC_CONNECTED state.

In some embodiments of the present application, the cell switch event may be a cell reselection event from cell#1 to cell#2 when the UE is in an RRC_INACTIVE or RRC_IDLE state.

In step 302, the UE may connect to cell#1 again, then the UE may transmit the information related to the cell switch event (from cell#1 to cell#2) to a BS of cell#1. In the embodiments of the present application, a cell switch event may also be referred to a last cell switch event or last time cell switch event.

In some embodiments of the present application, the information related to the cell switch event logged and reported by the UE may include at least one of the followings:
an ID representing cell#2. For example, the ID may be a cell global identity (CGI), physical cell identity (PCI), absolute radio-frequency channel number (ARFCN), or other ID which can represent cell#2.
a time stamp when the UE connects to cell#1 in the cell switch event (in other words, a time stamp when the UE connects to the cell#1 last time);
a time period that the UE stays in cell#1 before the cell switch event (in other words, a time period that the UE stays in cell#1 last time);
an indicator indicating whether the cell switch event is a handover event or a cell reselection event;
an indicator indicating whether the UE's current moving pattern is the same as a moving pattern when the UE connects to the cell#1 in the cell switch event (in other words, an indicator indicating whether the UE's current moving pattern is the same as a moving pattern when the UE connects to the cell#1 last time).

Consequently, in step 302, the BS may receive the information related to the cell switch event reported by the UE.

FIG. 4 illustrates a flowchart of another exemplary method for logging and reporting cell switch event according to some embodiments of the present application.

The method illustrated in FIG. 4 may be performed by a UE (e.g., UE 102a102a or UE 102b102b as shown in FIG. 1) and a BS (e.g., BS 101101 as shown in FIG. 1). Although the method is illustrated in a system level, persons skilled in the art can understand that the method implemented in the UE and the BS can be separately implemented and incorporated in other apparatus with the like functions.

Referring to FIG. 4, in step 401, a BS may transmit configuration information indicating a UE to log a cell switch event.

In some embodiments of the present application, the configuration information may be transmitted in a dedicated RRC message to the UE. In some other embodiments of the present application, the configuration information may be transmitted in a SIB message which are broadcasted to one or more UEs (e.g., all the UEs) including the UE in a cell coverage of the BS.

In some embodiments of the present application, the configuration information may include a list of cells that a UE can log cell switch events when the UE is connected to or camped on the list of cells. Alternatively or additionally, the configuration information may also include at least one of:
a time period that a UE can store a logged cell switch event (in other words, the information related to a cell switch event); for example, the time period may be several days (e.g., 1 day or 7 days);
a number of logs that a UE can store in total;
a number of logs that a UE can store for a same cell. In some embodiments, if the number of logs is not included in the configuration information, the UE may store a default number of logs for a same cell. For example, the default number may be 1. That is, for a same cell, the UE only store one log.
an indication indicating whether the UE should log a cell reselection event in an RRC_INACTIVE or RRC_IDLE state; or
information to be logged related to a cell switch event. For example, the
information to be logged by the UE may include the same content as those included in the information related to a cell switch event in FIG. 3.

In step 402, the UE may log and store information related to cell switch event(s) based on the configuration information. For example, for a cell (e.g., cell#1) in the list of cells, the UE may log and store information related to a cell switch event (e.g., from the cell#1 to cell#2) when the UE is connected to or camped on cell#1. The cell switch event may be a handover event from cell#1 to cell#2 when the UE is in an RRC_CONNECTED state or may be a cell reselection event from cell#1 to cell#2 when the UE is in an RRC_INACTIVE or RRC_IDLE state.

In step 403, the UE may connect to cell#1 again. Then, a BS of cell#1 may transmit a UE information request message (e.g., a UEINFORMATIONREQUEST message as specified in 3GPP standard documents) requesting the information related to the cell switch event to the UE.

After receiving the UE information request message, in step 404, the UE may transmit the information related to the cell switch event to the BS, for example, the information related to the cell switch event may be transmitted in a UE information response message (e.g., a UEINFORMATIONRESPONSE message as specified in 3GPP standard documents). In some examples, the information to be logged by the UE may include the same content as those included in the information related to a cell switch event in FIG. 3.

In the embodiments of FIG. 4, the BS transmitting configuration information and the BS transmitting UE information request message may be the same or different. For simplicity, FIG. 4 illustrates one BS as an example.

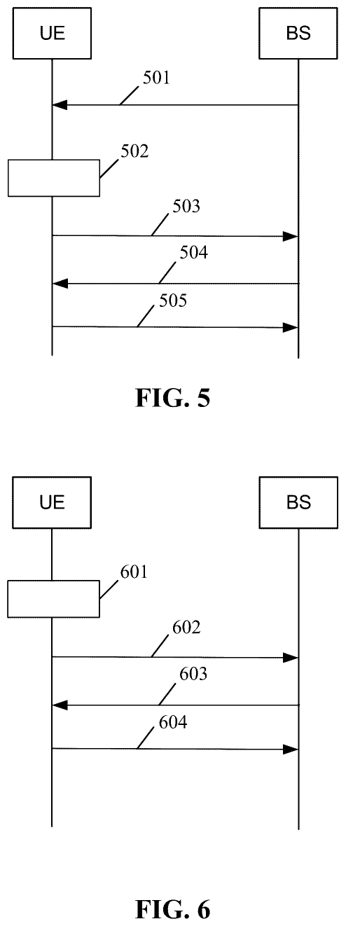

FIG. 5 illustrates a flowchart of another exemplary method for logging and reporting cell switch event according to some embodiments of the present application. The method illustrated in FIG. 5 may be performed by a UE (e.g., UE 102a or UE 102b as shown in FIG. 1) and a BS (e.g., BS 101 as shown in FIG. 1). Although the method is illustrated in a system level, persons skilled in the art can understand that the method implemented in the UE and the BS can be separately implemented and incorporated in other apparatus with the like functions.

Referring to FIG. 5, in step 501, a BS may transmit configuration information indicating a UE to log a cell switch event. The descriptions regarding the configuration information in FIG. 4 may apply here.

In such embodiments, the UE may log and store information related to cell switch event(s) based on the configuration information. For example, if a list of cells is included in the configuration information, for any cell in the list of cells, the UE may log and store information related to cell switch event(s). In another example, if a list of cells is not included in the configuration information, it is upon the UE's own decision regarding whether to log information related a cell switch event when the UE is connected to or camp on a cell. For example, in step 502, the UE may log and store information related to cell switch event (e.g., from the cell#1 to cell#2) when the UE is connected to or camped on cell#1. The cell switch event may be a handover event from cell#1 to cell#2 when the UE is in an RRC_CONNECTED state or may be a cell reselection event from cell#1 to cell#2 when the UE is in an RRC_INACTIVE or RRC_IDLE state.

In step 503, the UE may connect to cell#1 again. Then, the UE may transmit a message (e.g., an RRC message) indicating an availability of the information related to the cell switch event to a BS of cell#1.

After knowing the availability of the information related to the cell switch event, in step 504, the BS may transmit a UE information request message (e.g., a UEINFORMATIONREQUEST message as specified in 3GPP standard documents) requesting the information related to the cell switch event to the UE.

After receiving the UE information request message, in step 505, the UE may transmit the information related to the cell switch event to the BS, for example, the information related to the cell switch event may be transmitted in a UE information response message (e.g., a UEINFORMATIONRESPONSE message as specified in 3GPP standard documents). In some examples, the information to be logged by the UE may include the same content as those included in the information related to a cell switch event in FIG. 3.

In the embodiments of FIG. 5, the BS transmitting configuration information and the BS transmitting UE information request message may be the same or different. For simplicity, FIG. 5 illustrates one BS as an example.

FIG. 6 illustrates a flowchart of another exemplary method for logging and reporting cell switch event according to some embodiments of the present application. The method illustrated in FIG. 6 may be performed by a UE (e.g., UE 102a or UE 102b as shown in FIG. 1) and a BS (e.g., BS 101 as shown in FIG. 1). Although the method is illustrated in a system level, persons skilled in the art can understand that the method implemented in the UE and the BS can be separately implemented and incorporated in other apparatus with the like functions.

In the embodiments of FIG. 6, the UE does not receive configuration information from a BS. In such embodiments, it is upon the UE's own decision regarding whether to log information related a cell switch event when the UE is connected to or camp on a cell. For example, in step 601, the UE may log and store information related to cell switch event (e.g., from the cell#1 to cell#2) when the UE is connected to or camped on cell#1. The cell switch event may be a handover event from cell#1 to cell#2 when the UE is in an RRC_CONNECTED state or may be a cell reselection event from cell#1 to cell#2 when the UE is in an RRC_INACTIVE or RRC_IDLE state.

In step 602, the UE may connect to cell#1 again. The UE may transmit a message (e.g., an RRC message) indicating an availability of the information related to the cell switch event to a BS of cell#1.

Then, the BS and the UE may perform steps 603 and 604. Step 603 and 604 may be the same as steps 504 and 505 in FIG. 5, respectively.

The above embodiments illustrate that a UE may log and report information related to a cell switch event. However, in some other embodiments of the present application, in order to reduce the UE's storage requirement and processing burden, the UE may only store an ID of a cell switch event, and the BS may store the detailed information related to the cell switch event.

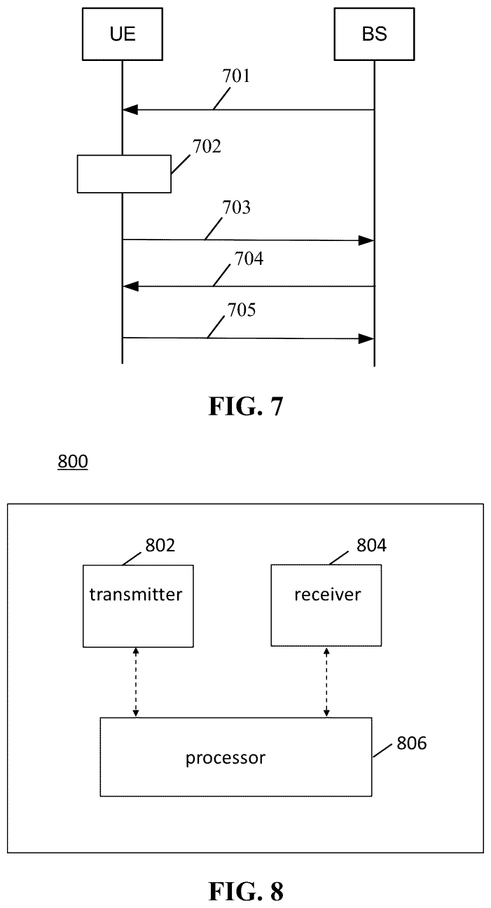

FIG. 7 illustrates a flowchart of another exemplary method for logging and reporting cell switch event according to some embodiments of the present application.

In the embodiments of FIG. 7, the cell switch event may be a handover event. When a BS configures a UE to perform a handover from a source cell (e.g., cell#1) to a target cell (e.g., cell#2), the BS may transmit an ID related to the handover event to the UE. For example, in step 701, the BS may transmit a message (e.g., an RRC message) including configuration related to the handover event and an ID of the handover event to the UE. In some embodiments, the message may also indicate how long the UE should store the ID given by the BS. In some embodiments, the ID of the handover event may be assigned by the BS itself, 5G-temporary mobile subscriber identity (TMSI), or any other ID which can represent the handover event.

After receiving the message, in step 702, the UE may log the ID of the handover event. After the handover procedure is finished, the BS may also store the ID together with the handover event (e.g., from cell#1 to cell#2).

In step 703, the UE may connect to cell#1 again. If the UE has stored the ID related to a cell switch event (e.g., a handover event from cell#1 to cell#2), the UE may transmit a message (e.g., an RRC message) indicating an availability of the information related to the cell switch event to a BS of cell#1.

After knowing the availability of the information related to the cell switch event, in step 704, the BS may transmit a UE information request message (e.g., a UEINFORMATIONREQUEST message as specified in 3GPP standard documents) requesting the information related to the cell switch event to the UE.

After receiving the UE information request message, in step 705, the UE may transmit the information related to the cell switch event (i.e., the ID of the handover event in FIG. 7) to the BS, for example, the information related to the cell switch event may be transmitted in a UE information response message (e.g., a UEINFORMATIONRESPONSE message as specified in 3GPP standard documents).

According to some embodiments of FIG. 7, before step 701, a BS (which may be the same as or different from the BS configuring a UE to perform a handover) may transmit configuration information indicating a UE to log a cell switch event.

In some embodiments of the present application, the configuration information may be transmitted in a dedicated RRC message to the UE. In some other embodiments of the present application, the configuration information may be transmitted in a SIB message which are broadcasted to one or more UEs (e.g., all the UEs) including the UE in a cell coverage of the BS.

In some embodiments of the present application, the configuration information may include may include at least one of:
a time period that the UE can store a logged cell switch event; for example, the time period may be several days (e.g., 1 day or 7 days);
a number of logs that a UE can store in total;
a number of logs that a UE can store for a same cell. In some embodiments, if the number of logs is not included in the configuration information, the UE may store a default number of logs for a same cell. For example, the default number may be 1. That is, for a same cell, the UE only store one log.
a list of cells that a UE can log cell switch events when the UE is connected to or camped on the list of cells;
an indication indicating whether the UE should log a cell reselection in an RRC_INACTIVE or RRC_IDLE state; or
information to be logged related to a cell switch event. For example, the information to be logged by the UE may be an ID of a handover event.

In such embodiments, after receiving the configuration information, the UE and the BS may perform steps 701-705. For example, in step 702, the UE may log information related to cell switch event(s) based on the configuration information. For example, in the case that a list of cells is included in the configuration information, the UE may log and store information related to a cell switch event (e.g., an ID of a handover event) when the UE is connected to or camped on any cell in the list of cells. According to some other embodiments of FIG. 7, the configuration information may be included in the message transmitted in step 701. That is, the message in step 701 may include configuration related to the handover event, an ID of the handover event to the UE, and the configuration information. Then, in step 702, the UE may log information related to cell switch event(s) based on the configuration information.

According to some embodiments of the present application, a BS may transmit a message (e.g., an RRC message) to a UE. The message may request the UE to indicate whether the UE is moving according to a fixed pattern. After receiving the message, the UE may determine whether it is moving according to a fixed pattern. For example, the UE may determine whether it is taking a same path as last time, connecting to a same cell as last time, and/or passing by a same location as last time. Then, the UE may transmit an indication (e.g., an RRC message) indicating whether the UE is moving according to a fixed pattern to the BS based on the determining.

For example, in the case that the UE determines that it is moving according to a fixed pattern (e.g., the UE is taking a same path as last time, connecting to a same cell as last time, and/or passing by a same location as last time), the UE may transmit an indication indicating that the UE is moving according to a fixed pattern to the BS. In such example, after receiving the indication, the BS may transmit configuration information as stated above to indicate the UE to log the information related a cell switch event, and thus the BS and the UE may perform the methods as illustrated in FIGS. 3-7.

FIG. 8 illustrates a simplified block diagram of an exemplary apparatus 800 for logging and reporting cell switch event according to some embodiments of the present application. In some embodiments, the apparatus 800 may be or include at least part of a UE (e.g., UE 102a or 102b in FIG. 1). In some other embodiments, the apparatus 800 may be or include at least part of a BS (e.g., BS 101 in FIG. 1).

Referring to FIG. 8, the apparatus 800 may include at least one transmitter 802, at least one receiver 804, and at least one processor 806. The at least one transmitter 802 is coupled to the at least one processor 806, and the at least one receiver 804 is coupled to the at least one processor 806.

Although in this figure, elements such as the transmitter 802, the receiver 804, and the processor 806 are illustrated in the singular, the plural can be contemplated unless a limitation to the singular is explicitly stated. In some embodiments of the present application, the transmitter 802 and the receiver 804 may be combined to one device, such as a transceiver. In some embodiments of the present application, the apparatus 800 may further include an input device, a memory, and/or other components. The transmitter 802, the receiver 804, and the processor 806 may be configured to perform any of the methods described herein (e.g., the methods described with respect to FIGS. 3-7 and other methods described in the embodiments of the present application).

According to some embodiments of the present application, the apparatus 800 may be a UE, and the transmitter 802, the receiver 804, and the processor 806 may be configured to perform operations of the UE in any of the methods as described with respect to FIGS. 3-7 and other methods described in the embodiments of the present application. For example, the processor 806 is configured to log information related to a cell switch event from a first cell to a second cell. The transmitter 802 is configured to transmit the information related to the cell switch event to a BS when the UE connects to the first cell again.

According to some embodiments of the present application, the apparatus 800 may be a BS, and the transmitter 802, the receiver 804, and the processor 806 may be configured to perform operations of the BS in any of the methods as described with respect to FIGS. 3-7 and other methods described in the embodiments of the present application. For example, the transmitter 802 is configured to transmit configuration information indicating to log a cell switch event to a UE. The receiver 804 is configured to receive information related to a cell switch event from a first cell to a second cell from the UE.

In some embodiments of the present application, the apparatus 800 may further include at least one non-transitory computer-readable medium. In some embodiments of the present disclosure, the non-transitory computer-readable medium may have stored thereon computer-executable instructions to cause the processor 806 to implement any of the methods as described above. For example, the computer- executable instructions, when executed, may cause the processor 806 to interact with the transmitter 802 and/or the receiver 804, so as to perform operations of the methods, e.g., as described with respect to FIGS. 3-7 and other methods described in the embodiments of the present application.

The method according to any of the embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for logging and reporting cell switch event, including a processor and a memory. Computer programmable instructions for implementing a method for logging and reporting cell switch event are stored in the memory, and the processor is configured to perform the computer programmable instructions to implement the method for logging and reporting cell switch event. The method for logging and reporting cell switch event may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for logging and reporting cell switch event according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A user equipment (UE) for wireless communication, comprising:
at least one memory; and
at least one processor coupled with the at least one memory and configured to cause the UE to:
log information related to a cell switch event from a first cell to a second cell; and
the information related to the cell switch event to a base station (BS) when the UE connects to the first cell again.

2. The UE of claim 1, wherein the cell switch event is a handover event when the UE is in a radio resource control (RRC)_CONNECTED state or a cell reselection event when the UE is in an RRC_INACTIVE or RRC_IDLE state.

3. The UE of claim 1, wherein the at least one processor is further configured to cause the UE to receive configuration information indicating the UE to log a cell switch event, the configuration information includes at least one of:
a time period that the UE can store a logged cell switch event;
a number of logs that the UE can store in total;
a number of logs that the UE can store for a same cell;
a list of cells that the UE can log cell switch events when the UE is connected to or camped on the list of cells, wherein the list of cells includes the first cell;
an indication indicating whether the UE should log a cell reselection in an RRC_INACTIVE or RRC_IDLE state; or
information to be logged related to a cell switch event.

4. The UE of claim 1, wherein the information related to the cell switch event includes at least one of:
an identity (ID) representing the second cell;
a time stamp when the UE connects to the first cell in the cell switch event;
a time period that the UE stays in the first cell before the cell switch event;
an indicator indicating whether the cell switch event is a handover event or a cell reselection event;
an indicator indicating whether a current moving pattern of the UE is the same as a moving pattern when the UE connects to the first cell in the cell switch event; or;
an ID of the cell switch event.

5. The UE of claim 3, wherein the configuration information is received in a dedicated RRC message to the UE or received in a system information block (SIB) message to one or more UEs including the UE.

6. The UE of claim 3, wherein the at least one processor is further configured to cause the UE to: receive a UE information request message requesting the information related to the cell switch event from the BS when the UE connects to the first cell again, and transmit the information related to the cell switch event in response to receiving the UE information request message.

7. The UE of claim 6,
wherein the at least one processor is further configured to cause the UE to transmit a message indicating an availability of the information related to the cell switch event to the BS when the UE connects to the first cell again.

8. The UE of claim 1,
wherein the cell switch event is a handover event,
wherein the at least one processor is further configured to cause the UE to receive a message including configuration related to the handover event and an ID of the handover event from the BS.

9. The UE of claim 8,
wherein the at least one processor is further configured to cause the UE to: transmit a message indicating an availability of the ID of the handover event when the UE connects to the first cell again;
receive a UE information request message requesting the ID of the handover event from the BS, and
transmit the ID of the handover event in response to receiving the UE information request message.

10. The UE of claim 1,
wherein the at least one processor is further configured to cause the UE to: receive a message requesting the UE to indicate whether the UE is moving according to a fixed pattern from the BS;
determine whether the UE is taking a same path as last time, connecting to a same cell as last time, or passing by a same location as last time in response to receiving the message; and
transmit an indication indicating whether the UE is moving according to a fixed pattern to the BS based on the determining.

11. A base station (BS) for wireless communication, comprising:
at least one memory; and
at least one processor coupled with the at least one memory and configured to cause the BS to:
transmit configuration information indicating to log a cell switch event to a user equipment (UE); and
receive information related to a cell switch event from a first cell to a second cell from the UE.

12. The BS of claim 11, wherein the configuration information includes at least one of:
a time period that the UE can store a logged cell switch event;
a number of logs that the UE can store in total;
a number of logs that the UE can store for a same cell;
a list of cells that the UE can log cell switch events when the UE is connected to or camped on the list of cells, wherein the list of cells includes the first cell;
an indication indicating whether the UE should log a cell reselection in an RRC_INACTIVE or RRC_IDLE state; or information to be logged related to a cell switch event.

13. The BS of claim 11, wherein the information related to the cell switch event includes at least one of:
an identity (ID) representing the second cell;
a time stamp when the UE connects to the first cell in the cell switch event;
a time period that the UE stays in the first cell before the cell switch event;
an indicator indicating whether the cell switch event is a handover event or a cell reselection event or
an indicator indicating whether the UE's current moving pattern is the same as a moving pattern when the UE connects to the first cell in the cell switch event.

14. The BS of claim 11, wherein the at least one processor is further configured to cause the BS to:
transmit a message requesting the UE to indicate whether the UE is moving according to a fixed pattern from the BS; and
receive an indication indicating whether the UE is moving according to a fixed pattern from the UE in response to the message.

15. A method performed by a user equipment (UE), comprising:
logging information related to a cell switch event from a first cell to a second cell; and
transmitting the information related to the cell switch event to a base station (BS) when the UE connects to the first cell again.

16. A processor for wireless communication, comprising:
at least one controller coupled with at least one memory and configured to cause the processor to:
log information related to a cell switch event from a first cell to a second cell; and
transmit the information related to the cell switch event to a base station (BS) when the processor connects to the first cell again.

17. The processor of claim 16, wherein the cell switch event is a handover event when the processor is in a radio resource control (RRC)_CONNECTED state or a cell reselection event when the processor is in an RRC_INACTIVE or RRC_IDLE state.

18. The processor of claim 16, wherein the at least one controller is further configured to cause the processor to receive configuration information indicating the processor to log a cell switch event, the configuration information includes at least one of:
a time period that the processor can store a logged cell switch event;
a number of logs that the processor can store in total;
a number of logs that the processor can store for a same cell;
a list of cells that the processor can log cell switch events when the processor is connected to or camped on the list of cells, wherein the list of cells includes the first cell;
an indication indicating whether the processor should log a cell reselection in an RRC_INACTIVE or RRC_IDLE state; or information to be logged related to a cell switch event.

19. The processor of claim 16, wherein the information related to the cell switch event includes at least one of:
an identity (ID) representing the second cell;
a time stamp when the processor connects to the first cell in the cell switch event;
a time period that the processor stays in the first cell before the cell switch event;
an indicator indicating whether the cell switch event is a handover event or a cell reselection event;
an indicator indicating whether a current moving pattern of the processor is the same as a moving pattern when the processor connects to the first cell in the cell switch event; or;
an ID of the cell switch event.

20. The processor of claim 16,
wherein the cell switch event is a handover event,
wherein the at least one controller is further configured to cause the processor to receive a message including configuration related to the handover event and an ID of the handover event from the BS.
